(19) United States
(12) Patent Application Publication
(10) Pub. No.: US 2020/0006804 A1
(43) Pub. Date: Jan. 2, 2020

(54) Lithium Ion Battery Silicate Positive Electrode Material, and Preparation and Application Thereof

(71) Applicant: Ningbo Institute of Materials Technology & Engineering, Chinese Academy of Sciences, Zhejiang (CN)

(72) Inventors: Zhifeng Zhang, Zhejiang (CN); Zhenlien Chen, Zhejiang (CN); Jun Li, Zhejiang (CN); Xianhui Zhang, Zhejiang (CN)

(21) Appl. No.: 16/488,545

(22) PCT Filed: Apr. 18, 2018
(86) PCT No.: PCT/CN2018/083524

§ 371 Date: Aug. 23, 2019

(30) Foreign Application Priority Data
Feb. 23, 2017 (CN) 201710099294.1

(51) Int. Cl. H01M 10/0525; H01M 4/133; H01M 4/136; H01M 4/36; H01M 4/58; H01M 4/587

(52) U.S. Cl. CPC H01M 10/0525; H01M 4/133; H01M 4/136; H01M 2004/028; H01M 4/5825; H01M 4/587; H01M 4/366

(57) ABSTRACT

The present invention relates to a lithium ion battery silicate positive electrode material, and the preparation and an application thereof. Specifically, a silicate positive electrode material is disclosed, which includes a core LiₐCoₓT₁₋ₓSi_{y}M_{1-y}O₄ and a carbon coating layer coated on an outer surface of the core. Also disclosed are the preparation and an application of the positive electrode material. A lithium ion battery prepared using the positive electrode material as a positive electrode active material has a discharge capacity greater than 130 mAh/g under a discharge density of 5 mA/g, and a discharge voltage platform greater than 4V.

### BACKGROUND OF THE INVENTION

### Field of the Invention

The invention relates to the field of materials, in particular to a lithium ion battery silicate positive electrode material and preparation and application thereof.

### Description of Related Art

As an alkali metal ion secondary battery, a lithium ion battery is considered to be the most promising energy storage system due to its high capacity and is widely used in various portable devices. Compared with traditional nickel-metal hydride batteries, nickel-cadmium batteries, and lead-acid batteries, lithium-ion batteries not only provide 2-3 times higher energy density and 5-6 times higher power density than above batteries, but also have the advantages such as long cycle life, high average output voltage, large output power, no memory effect, and small self-discharge. However, as the development of lithium-ion batteries for applications from small portable devices to high-power energy storage devices, especially power supplies, the energy density requirements are getting higher and higher, but the limitations of the cathode materials hinder further development of lithium ion batteries.

The commonly used cathode materials currently are lithium cobalt oxide (LiCoO₂), lithium manganate (LiMn₂O₄), lithium iron phosphate (LiFePO₄), lithium nickel cobalt manganese ternary material (LiNi_{1/3}Co_{1/3}Mn_{1/3}O₂) etc. These positive electrode materials all have a structural unit of metal or non-metal oxygen ion hexahedron group, which can only provide one lithium ion insertion and extraction, and limit the theoretical range of the reversible capacity of the positive electrode material. And its low insertion potential (CV peak <4V) limits the space for increasing its discharge energy density, which greatly restricts their development potential in new 5V battery technology and their industry application in large energy storage equipment and power supply. Therefore, there is an urgent need in the field of electrochemical energy storage to develop a cathode material with higher energy density and better cost performance to meet the technical requirements of high energy density batteries in the new energy industry.

Orthosilicate (Li₂TSiO₄, T=Fe, Mn, Co, Ni) is another new type of polyanionic lithium ion battery cathode material in addition to lithium iron phosphate. Since Si and P are located adjacent to each other in the same period in the periodic table, silicates and phosphates have similar chemical properties. And, the Si—O bond has a stronger chemical bond synthesis than the P—O bond, making Li₂TSiO₄ have more stable crystal structure. Compared with phosphate materials, orthosilicates have a structural unit of metal or non-metal oxygen ion tetrahedral groups, theoretically allowing the insertion and extraction of two lithium ions (T²⁺/T³⁺, T³⁺/T₄₊ redox couple), so they have a theoretical capacity twice of the hexahedral oxygen ion group cathode material. This makes silicate material a very attractive new structure for high capacity lithium ion battery cathode materials. The silicate lithium ion battery cathode material Li₂TSiO₄ (T=Fe, Mn, Co) is increasingly accepted by academics and industry areas due to its low cost, high energy density and good safety performance.

In 2005, Dr. Nyten from Uppsala University in Sweden reported for the first time a new type of silicate lithium ion battery cathode material Li₂FeSiO₄, in which Li₂FeSiO₄/C cathode material synthesized by solid phase sintering has good electrochemical properties. By Xrd analysis of synthetic samples, it is found that all cations exist in tetrahedral coordination form. The crystal structure belongs to orthorhombic system, and the space group is Pmn2₁, and the lattice parameters are: a=6.2661(5), b=5.3295(5), c=5.0148(4). When charging and discharging at 60° C., C/16 (20 mA/g), the first two charging capacities can reach 165 mAh/g, which is very close to the theoretical capacity when lithium is deintercalated, and the discharge capacity is 120 mAh/g. With constantly improvement in nanotechnology and carbon coating synthesis, Li₂FeSiO₄ and Li₂MnSiO₄ experimentally synthesized by Dinesh Rangappa et al. in 2012 have achieved reversible deintercalation of nearly two lithium ions, indicating the stability capacity has exceeded 300 mAh/g, which is not only twice of the capacity reported for the first time 140-165 mAh/g, but also twice of the olivine structure LiFePO₄ capacity (160-170 mAh/g), confirming that the silicate cathode material can increase the energy density of lithium-ion batteries by nearly two times. However, the above experiments show that the discharge voltages of Li₂FeSiO₄ and Li₂MnSiO₄ are less than 3V, and during the electrochemical cycle, the charging voltage between the first and subsequent cycles undergoes a structural voltage drop phenomenon; and the micro-nano structure of Li₂MnSiO₄ material transforms into an amorphous structure during electrochemical cycle. The charge and discharge voltage platform of experimentally prepared Li₂CoSiO₄ is greater than 4V, and three polymorphic materials with a symmetry as Pmn2₁, Pbn2₁ and P2₁/n did not show signs of structural voltage drop during charge and discharge. However, due to the difficulty in preparation of cobalt-based materials, so far, the discharge specific capacity of Li₂CoSiO₄ polymorphic material has been lower than 100 Ah/kg in the discharge window of 2.0-4.6V, and the progress of electrochemical performance is far behind iron, manganese silicate.

Therefore, the development of suitable material modification technology and the improvement of the specific capacity of cobalt-based silicate materials are the main difficulties and challenges in the research and development of silicate materials over the past decade.

### BRIEF SUMMARY OF THE INVENTION

The object of the present invention is to provide a lithium ion battery cobalt-based silicate positive electrode material and preparation and application thereof.

In a first aspect of the present invention, a silicate positive electrode material is provided, wherein the silicate positive electrode material comprises a core of LiₐCoₓT₁₋ₓSi_{y}M_{1-y}O₄ and a carbon coating layer coated on an outer surface of the core, and the silicate positive electrode material comprises a composition of formula I:

LiₐCoₓT₁₋ₓSi_{y}M_{1-y}O₄/C I

wherein T is a metal ion of metal elements selected from the group consisting of Mn, Fe, Ni, Ca, Mg, Al, La, Y, Sc, Zn, Cu, V, Mo, Tc, Ru, Rh, Pd, Cr, and a combination thereof; and the valence of T is the same as the valence of Co in Formula I;

M is a ion of elements selected from the group consisting of P, V, Ti, Ge, Ga, N, F, S, and a combination thereof;

0<x≤1, 0<y≤1, and not both of x and y are 1;

the value of a makes total valence of the core of LiₐCoₓT₁₋ₓSi_{y}M_{1-y}O 0.

In another preferred embodiment, a is selected from the group consisting of 2 and 1.9.

In another preferred embodiment, when T is V and M is V, the valence of V is 3+ for T, and the valence of V is 5+ for M.

In another preferred embodiment, 0.01<x≤1, preferably 0.1<x≤1, more preferably 0.3<x≤1, and most preferably 0.5<x≤1.

In another preferred embodiment, 0.01<y≤1, preferably 0.1<y≤1, more preferably 0.3<y≤1, and most preferably 0.5<y≤1.

In another preferred embodiment, the silicate positive electrode material is a solid solution material.

In another preferred embodiment, “the silicate positive electrode material is a solid solution material” means that when the valence of T is the same as the valence of Co in formula I, T partially replaces Co in the Co oxytetrahedron to form T oxytetrahedron anion group.

In another preferred embodiment, both T and Co are the solid solution components in the silicate positive electrode material.

In another preferred embodiment, the valence of Co and T in Formula I is selected from the group consisting of +2, +3, and a combination thereof.

In another preferred embodiment, M is a doping element in the silicate positive electrode material.

In another preferred embodiment, “M is a doping element in the silicate positive electrode material” means that M is a doping element in the Si oxytetrahedron anion group.

In another preferred embodiment, the silicate positive electrode material is a polymorphic material.

In another preferred embodiment, “the silicate positive electrode material is a polymorphic material” means that the silicate positive electrode material comprises Pmn2₁ phase and optionally the phase selected from the group consisting of Pbn2₁ phase, P2ᵢ/n phase, and a combination thereof.

In another preferred embodiment, the silicate positive electrode material has a bimodal group characteristic, and preferably, the bimodal group characteristic is stably present during a charge and discharge cycle.

In another preferred embodiment, the silicate positive electrode material simultaneously comprises two types of tetrahedral oxygen ion groups: a T-substituted or unsubstituted Co oxytetrahedron oxygen ion group, and M-doped or undoped Si oxytetrahedron oxygen ion group.

In another preferred embodiment, the silicate positive electrode material has a particle diameter of 5 to 500 nm.

In another preferred embodiment, the silicate positive electrode material has a particle diameter of 10 to 300 nm, preferably 15 to 200 nm, more preferably 20 to 100 nm.

In another preferred embodiment, the core of Li₂CoₓT₁₋ₓSi_{y}M_{1-y}O₄ has a diameter of 15-100 nm, preferably 20-100 nm.

In another preferred embodiment, the carbon coating layer has a thickness of 10 to 100 nm, preferably 20 to 50 nm.

In another preferred embodiment, the silicate positive electrode material is in the form of particles.

In another preferred embodiment, the silicate positive electrode material has one or more characteristics selected from the group consisting of:

1) when a lithium ion battery prepared by using the silicate positive electrode material as a positive electrode active material is discharged at a current density of 5 mA/g, the reversible discharge specific capacity is higher than 130 Ah/kg;

2) the discharge voltage platform of a lithium ion battery prepared by using the silicate positive electrode material as a positive electrode active material is higher than 4V;

3) a lithium ion battery prepared by using the silicate positive electrode material as a positive electrode active material does not exhibit a structural voltage drop during the cycle.

In a second aspect of the present invention, a method for preparing the silicate positive electrode material according to the first aspect of the present invention is provided, wherein the method comprises the following steps:

1) providing a first solution, a second solution, and a carbon source material, wherein the first solution comprises a first solvent, a lithium source material, and a silicon source material;

the second solution comprises a second solvent, a cobalt source material, a T source material, and/or an M source material;

2) mixing the first solution and the second solution under stirring to obtain a precursor solution;

3) transferring the precursor solution to a reaction vessel, and reacting for time t1 at a first temperature T1;

4) suction filtrating and optionally washing and drying the product obtained in step 3) to obtain the core of the silicate positive electrode material in the first aspect of the present invention;

5) mixing the product obtained in step 4) with the carbon source material, and calcining the resulting mixture at the second temperature T2 for time t2 to obtain the silicate positive electrode material of the first aspect of the present invention.

In another preferred embodiment, the first solvent is selected from the group consisting of water, ethanol, ethylene glycol, aqueous ammonia, and a combination thereof, preferably deionized water.

In another preferred embodiment, the second solvent is selected from the group consisting of ethylene glycol, water, ethanol, and a combination thereof.

In another preferred embodiment, the lithium source material is selected from the group consisting of lithium hydroxide, lithium oxide, and a combination thereof;

the silicon source material is selected from the group consisting of silicon oxide, tetraethyl orthosilicate, methyl orthosilicate, silicate, silicone, and a combination thereof; the cobalt source material is a cobalt salt selected from the group consisting of acetate, hydrochloride, sulfate, nitrate, carbonate, hydrogencarbonate, citrate, halogenated salt, and a combination thereof;

the T source material is a T salt selected from the group consisting of acetate, hydrochloride, sulfate, nitrate, carbonate, hydrogencarbonate, citrate, halogenated salt, and a combination thereof;

the M source material is a substance comprising M element selected from the group consisting of an acid, an ammonium salt, an oxide, a lipid substance;

the carbon source material is an organic carbon source, preferably selected from the group consisting of glucose, sucrose, citric acid, oxalic acid, acetic acid, and a combination thereof.

In another preferred embodiment, T1 is 130-180° C., preferably 140-170° C., more preferably 145-160° C.;

t1 is 1-150 h, preferably 10-100 h, more preferably 20-85 h;

T2 is 400-800° C., preferably 500-700° C.;

t2 is 0.1 to 5 h, preferably 0.5 to 3 h.

In another preferred embodiment, the mixing ratio of the product obtained in step 4) to the carbon source material in step 5) is 1-5:1, preferably 2-3.5:1.

In a third aspect of the present invention, a lithium ion battery positive electrode is provided, wherein the positive electrode active material of the positive electrode comprises or consists of the silicate positive electrode material of the first aspect of the present invention.

In another preferred embodiment, the positive electrode further comprises a conductive agent and a binder.

In a fourth aspect of the present invention, a lithium ion battery is provided, wherein the lithium ion battery comprises the positive electrode of the third aspect of the present invention.

It should be understood that in the present invention, any of the technical features specifically described above and below (such as in the Examples) can be combined with each other, which will not redundantly be described one by one herein.

### BRIEF DESCRIPTION OF THE SEVERAL VIEWS OF THE DRAWINGS

FIG. 1 is an XRD pattern of Li_{1.9}CoSi_{0.9}P_{0.1}O₄ and Li_{1.9}CoSi_{0.9}P_{0.1}O₄/C obtained in Example 1.

FIG. 2 is an SEM picture of Li_{1.9}CoSi_{0.9}P_{0.1}O₄ obtained in Example 1.

FIG. 3 shows the charge and discharge test results for lithium ion batteries using Li_{1.9}CoSi_{0.9}P_{0.1}O₄ and Li_{1.9}CoSi_{0.9}P_{0.1}O₄/C obtained in Example 1 as positive electrode active materials, respectively.

FIG. 4 is an XRD pattern of Li_{1.9}CoSi_{0.9}V_{0.1}O₄ and Li_{1.9}CoSi_{0.9}V_{0.1}O₄/C obtained in Example 2.

FIG. 5 is an SEM picture of Li_{1.9}CoSi_{0.9}V_{0.1}O₄ obtained in Example 2.

FIG. 6 shows the charge and discharge test results for lithium ion batteries using Li_{1.9}CoSi_{0.9}V_{0.1}O₄ and Li_{1.9}CoSi_{0.9}V_{0.1}O₄/C obtained in Example 2 as positive electrode active materials, respectively.

FIG. 7 is an XRD pattern of Li₂Co_{0.9}Mn_{0.1}SiO₄ and Li₂Co_{0.9}Mn_{0.1}SiO₄/C obtained in Example 3.

FIG. 8 is an SEM picture of Li₂Co_{0.9}Mn_{0.1}SiO₄ obtained in Example 3.

FIG. 9 shows the charge and discharge test results for lithium ion batteries using Li₂Co_{0.9}Mn_{0.1}SiO₄ and Li₂Co_{0.9}Mn_{0.1}SiO₄/C obtained in Example 3 as a positive electrode active material, respectively.

FIG. 10 is an XRD pattern of Li₂CoSiO₄ and Li₂CoSiO₄/C obtained in Comparative Example 1.

FIG. 11 is an SEM picture of Li₂CoSiO₄ obtained in Comparative Example 1.

FIG. 12 shows the charge and discharge test result for a lithium ion battery using Li₂CoSiO₄ and Li₂CoSiO₄/C obtained in Comparative Example 1 as positive electrode active materials, respectively.

### DETAILED DESCRIPTION OF THE INVENTION

Through extensive and intensive long research, the inventors unexpectedly prepared a lithium ion battery silicate positive electrode material with a stable structure, good chemical properties, a simple and controllable preparation process, good safety and low cost. On this basis, the inventors have completed the present invention.

Silicate Positive Electrode Material

Specifically, the present invention provides a silicate positive electrode material, wherein the silicate positive electrode material comprises a core of LiₐCoₓT₁₋ₓSi_{y}M_{1-y}O₄ and a carbon coating layer coated on an outer surface of the core, and the silicate positive electrode material comprises a composition of formula I:

LiₐCoₓT₁₋ₓSi_{y}M_{1-y}O₄/C I

wherein T is a metal ion of metal elements selected from the group consisting of Mn, Fe, Ni, Ca, Mg, Al, La, Y, Sc, Zn, Cu, V, Mo, Tc, Ru, Rh, Pd, Cr, and a combination thereof; and the valence of T is the same as the valence of Co in Formula I;

M is n ion of elements selected from the group consisting of P, V, Ti, Ge, Ga, N, F, S, and a combination thereof;

0<x≤1, 0<y≤1, and not both of x and y are 1;

the value of a makes total valence of the core of LiₐCoₓT₁₋ₓSi_{y}M_{1-y}O₄0.

In another preferred embodiment, a is selected from the group consisting of 2 and 1.9.

In another preferred embodiment, when T is V and M is V, the valence of V is 3+ for T, and the valence of V is 5+ for M.

In another preferred embodiment, 0.01<x≤1, preferably 0.1<x≤1, more preferably 0.3<x≤1, and most preferably 0.5<x≤1.

In another preferred embodiment, 0.01<y≤1, preferably 0.1<y≤1, more preferably 0.3<y≤1, and most preferably 0.5<y≤1.

In the present invention, the silicate positive electrode material is a solid solution material.

In another preferred embodiment, “the silicate positive electrode material is a solid solution material” means that when the valence of T is the same as the valence of Co in formula I, T partially replaces Co in the Co oxytetrahedron to form T oxytetrahedron anion group.

In another preferred embodiment, both T and Co are the solid solution components in the silicate positive electrode material.

In another preferred embodiment, the valence of Co and T in Formula I is selected from the group consisting of +2, +3, and a combination thereof.

In the present invention, M is a doping element in the silicate positive electrode material.

In another preferred embodiment, “M is a doping element in the silicate positive electrode material” means that M is a doping element in the Si oxytetrahedron anion group.

In another preferred embodiment, the silicate positive electrode material is a polymorphic material.

In another preferred embodiment, “the silicate positive electrode material is a polymorphic material” means that the silicate positive electrode material comprises Pmn2₁ phase and optionally the phase selected from the group consisting of Pbn2₁ phase, P2₁/n phase, and a combination thereof.

In another preferred embodiment, the silicate positive electrode material has a bimodal group characteristic, and preferably, the bimodal group characteristic is stably present during a charge and discharge cycle.

In another preferred embodiment, the silicate positive electrode material simultaneously comprises two types of tetrahedral oxygen ion groups: a T-substituted or unsubstituted Co oxytetrahedron oxygen ion group, and M-doped or undoped Si oxytetrahedron oxygen ion group.

In the present invention, the silicate positive electrode material has a particle diameter of 5 to 500 nm.

In another preferred embodiment, the silicate positive electrode material has a particle diameter of 10 to 300 nm, preferably 15 to 200 nm, more preferably 20 to 100 nm.

In another preferred embodiment, the core of Li₂CoₓT₁₋ₓSi_{y}M_{1-y}O₄ has a diameter of 15-100 nm, preferably 20-100 nm.

In another preferred embodiment, the carbon coating layer has a thickness of 10 to 100 nm, preferably 20 to 50 nm.

In another preferred embodiment, the silicate positive electrode material is in the form of particles.

In the present invention, the silicate positive electrode material has one or more characteristics selected from the group consisting of:

1) when a lithium ion battery prepared by using the silicate positive electrode material as a positive electrode active material is discharged at a current density of 5 mA/g, the reversible discharge specific capacity is higher than 130 Ah/kg;

2) the discharge voltage platform of a lithium ion battery prepared by using the silicate positive electrode material as a positive electrode active material is higher than 4V;

3) a lithium ion battery prepared by using the silicate positive electrode material as a positive electrode active material does not exhibit a structural voltage drop during the cycle.

More specifically, the present invention provides a polymorphic silicate solid solution material comprising the composition of Formula I, wherein 0<x≤1, and 0<y≤1, and T is a solid solution component, and M is a doping component; the material particles are in the range of 5-200 nm, and the Xrd has a bimodal group characteristic; the lithium ion battery prepared by using the solid solution material as the positive electrode active material does not undergo a structural voltage change during the charge and discharge cycle, and V has a stable discharge platform, and a discharge reversible specific capacity higher than 130 Ah/kg can be obtained.

More specifically, the present invention discloses a polymorphic silicate solid solution material composed of a tetrahedral oxygen ion group, wherein the solid solution material has the chemical formula of Formula I:

LiₐCoₓT₁₋ₓSi_{y}M_{1-y}O₄ I

wherein 0<x≤1, 0<y≤1, and T is a metal element selected from the group consisting of Mn, Fe, Ni, Ca, Mg, Al, La, Y, Sc, Li, Zn, Cu, V, Mo, Tc, Ru, Rh, Pd, Cr and a combination thereof; M is an element selected from the group consisting of P, V, Ti, Ge, Ga, Al, N, F, S and a combination thereof;

further, Co and T are metal ions having a nominal valence of +2, forming a tetrahedral anion group with oxygen ions, which is a solid solution component in a polymorphic crystal lattice; M is a metal or non-metal doping component in a skeleton structure composed of Si oxygen tetrahedral units, with different nominal valences;

and, when the lithium ion battery prepared by using the solid solution material as a positive electrode active material is discharged at a current density of 5 mA/g at room temperature, the reversible discharge specific capacity is higher than 130 Ah/kg, and the voltage platform shows no movement caused by structural phase transition during the charge and discharge cycle.

And, the Xrd structure polymorphism of the solid solution material composed of tetrahedral oxygen ion group includes one or more of the bimodal group characteristics in Pmn2₁, Pbn2₁ and P2ᵢ/n phase, and the bimodal group characteristics do not change during the charge and discharge process; preferably Pmn2₁.

In another preferred embodiment, the bimodal group characteristics refer to the Pmn2₁, Pbn2₁ and P2ᵢ/n phase XRD patterns of the polymorphic material have obvious bimodal structure at 21.8° and 23.1°, including peak groups such as bimodal-bimodal, unimodal-trimodal; the bimodal group characteristics depend on the preparation conditions, but do not change with the charge-discharge cycle process.

In another preferred embodiment, the solid solution material is in the form of particles, and the polymorphic solid solution material has a particle diameter of 5 to 200 nm, preferably 5 to 30 nm, 30 to 60 nm, or 60 to 90 nm.

In another preferred embodiment, Pmn2₁ phase material is modified by M doping at silicon-site skeleton and particulate carbon coating, and the polymorphic material does not phase into a mixed phase but remains as Pmn2₁ phase, and does not change with the charge and discharge cycle process.

In another preferred embodiment, after solid solution, doping, and carbon coating modification, the lithium ion battery prepared by using the polymorphic solid solution material as a positive electrode active material is charged and discharged at 5 mA/g in a voltage range of 2.5-4.6 V, its discharge specific capacity is not less than 130 mAh/g, while the charge platform is maintained at about 4.3V, and the discharge platform is maintained at about 4.1V, there will be no structural voltage drop during the cycle. Specifically, a significant voltage drop occurs during the first to second cycles in the Li2FeSiO₄ and Li2MnSiO₄ materials, and it is not present in the Li₂CoSiO₄ material from the first to the second cycles.

Preferably, the T element is selected from +2 or +3 valent metal element and a combination thereof.

Preferably, the M element is selected from a high valence metal or non-metal element and a combination thereof.

Preferably, the charging platform of the positive electrode material is about 4.3 V, and the discharge platform is about 4.1 V.

Preferably, Pmn2₁ is preferable in the polymorphic feature of the solid solution material composed of the tetrahedral oxygen ion groups.

It should be understood that the carbon coating layer on the outer surface of the positive electrode material of the present invention can effectively improve the electrochemical activity of the obtained positive electrode material.

It should be understood that in the existing typical silicate positive electrode material Li₂CoSiO₄, both Co oxygen tetrahedron and Si oxygen tetrahedron anion group are present.

Preparation Method

The present invention also provides a method for preparing the silicate positive electrode material, wherein the method comprises the following steps:

1) providing a first solution, a second solution, and a carbon source material, wherein

the first solution comprises a first solvent, a lithium source material, and a silicon source material;

the second solution comprises a second solvent, a cobalt source material, a T source material, and/or an M source material;

2) mixing the first solution and the second solution under stirring to obtain a precursor solution;

3) transferring the precursor solution to a reaction vessel, and reacting for time t1 at a first temperature T1;

4) suction filtrating and optionally washing and drying the product obtained in step 3) to obtain the core of the silicate positive electrode material;

5) mixing the product obtained in step 4) with the carbon source material, and calcining the resulting mixture at a second temperature T2 for time t2 to obtain the silicate positive electrode material.

In another preferred embodiment, the first solvent is selected from the group consisting of water, ethanol, ethylene glycol, aqueous ammonia, and a combination thereof, preferably deionized water.

In another preferred embodiment, the second solvent is selected from the group consisting of ethylene glycol, water, ethanol, and a combination thereof.

In the present invention the lithium source material is selected from the group consisting of lithium hydroxide, lithium oxide, and a combination thereof;

the silicon source material is selected from the group consisting of silicon oxide, tetraethyl orthosilicate, methyl orthosilicate, silicate, silicone, and a combination thereof; the cobalt source material is a cobalt salt selected from the group consisting of acetate, hydrochloride, sulfate, nitrate, carbonate, hydrogencarbonate, citrate, halogenated salt, and a combination thereof;

the T source material is a T salt selected from the group consisting of acetate, hydrochloride, sulfate, nitrate, carbonate, hydrogencarbonate, citrate, halogenated salt, and a combination thereof;

the M source material is a substance comprising M element selected from the group consisting of an acid, an ammonium salt, an oxide, a lipid substance;

the carbon source material is an organic carbon source, preferably selected from the group consisting of glucose, sucrose, citric acid, oxalic acid, acetic acid, and a combination thereof.

In the present invention, T1 is 130-180° C., preferably 140-170° C., more preferably 145-160° C.;

t1 is 1-150 h, preferably 10-100 h, more preferably 20-85 h; T2 is 400-800 ° C., preferably 500-700° C.; t2 is 0.1 to 5 h, preferably 0.5 to 3 h.

In another preferred embodiment, the mixing ratio of the product obtained in step 4) to the carbon source material in step 5) is 1-5:1, preferably 2-3.5:1.

Application

The present invention also provides a lithium ion battery positive electrode, wherein the positive active material of the positive electrode comprises or consists of the silicate positive electrode material.

In another preferred embodiment, the positive electrode further comprises a conductive agent and a binder.

The invention also provides a lithium ion battery comprising the positive electrode.

Compared with the prior art, the present invention has the following main advantages.

(1) The silicate positive electrode material has the advantages of high energy density, good safety, low cost, and stable structure.

(2) The preparation method of the silicate positive electrode material is simple and controllable, with good safety and low cost.

(3) The lithium ion battery with the silicate positive electrode material as the positive electrode active material can have a charging capacity of up to 304 mAh/g and a discharge capacity as high as 155 mAh/g at 5 mA/g; the discharge voltage of the Li-ion batteries can be up to 4.1V.

The present invention will be further illustrated below with reference to the specific examples. It should be understood that these examples are only to illustrate the invention but not to limit the scope of the invention. The experimental methods with no specific conditions described in the following examples are generally performed under the conventional conditions, or according to the manufacture's instructions. Unless indicated otherwise, parts and percentage are calculated by weight.

Unless otherwise defined, all professional and scientific terminology used in the text have the same meanings as known to the skilled in the art. In addition, any methods and materials similar or equal with the record content can apply to the methods of the invention.

The method of the preferred embodiment described herein and the material are only for demonstration purposes.

General Test Method

XRD

XRD equipment used is XRD-6100 from Shimadzu, and the radiation source is Cu-Kα (λ=1.5418 Å).

SEM

SEM used is QUANTA 250 FEG from FEI.

Charge and discharge performance

Preparation of lithium ion battery

The silicate positive electrode material obtained by the present invention is respectively mixed with the conductive agent acetylene black and the binder polyvinylidene fluoride (PVDF) in a solvent of nitrogen methylpyrrolidone (NMP). The mass ratio of the silicate positive electrode material, acetylene black and the binder is 80:10:10. And then the obtained slurry is coated onto an aluminum foil, dried, sliced, and tableted to obtain a positive electrode tab of a lithium ion battery. The positive electrode tab, the separator, the electrolyte, and the negative electrode were assembled into a CR2032 button battery in a glove box protected by a high purity argon atmosphere. The negative electrode is lithium, and the separator is Celgard 2550, and the electrolyte is 1M LiPF₆ dissolved in EC/DMC with a volume ratio of 1:1.

Charge and Discharge Performance Test

The battery is charged and discharged using Blue Power 2001 A, at a room temperature of 25° C., with a voltage of 2.5-4.6V.

### EXAMPLE 1

### Silicate Positive Electrode Material 1 (Li_{1.9}CoSi_{0.9}P_{0.1}O₄/C)

1.1 Weighing lithium hydroxide (such as 1.2 mol) and silica nanopowder (such as 0.27 mol) with the molar ratio of Li to Si of 4:1, adding deionized water and fully stirred, configured as a suspension, and then placed in the ultrasonic device for 3 h;

1.2 Weighing the appropriate amount of cobalt chloride (such as 0.3 mol) and H₃PO₄ (such as 0.03 mol), fully dissolved in ethylene glycol;

1.3 Adding the solution obtained in 1.2 slowly and uniformly to the solution obtained in 1.1, stirred, rotated at 1500 rpm;

1.4 Transferring the mixed solution obtained in 1.3 to the reaction vessel, and reacted at 150° C. for 72 h;

1.5 The reaction product obtained in 1.4 was suction filtered, washed for several times and dried;

1.6 The dried product obtained in 1.5 (such as 1.5 g) was mixed with sucrose (such as 0.42 g), ball milled for 12 h, then placed in a tube furnace, heated to 600° C. at 5° C./min in an inert atmosphere and calcined for 1 h;

1.7 The product was taken out after natural cooling, and the obtained product was the obtained silicate positive electrode material 1.

Result

The dried product obtained in 1.5 and the silicate positive electrode material 1 obtained in 1.7 were respectively subjected to ICP (Inorganic Element Analysis), XRD and SEM tests, and lithium ion batteries respectively using the dried product obtained in 1.5 and the silicate positive electrode material 1 obtained in 1.7 as positive electrode active materials were tested for charge and discharge and cycle performance.

Detected by ICP, the dried product obtained in 1.5 has a composition of Li_{1.9}CoSi_{0.9}P_{0.1}O₄, the silicate positive electrode material 1 obtained in 1.7 has a composition of Li_{1.9}CoSi_{0.9}P_{0.1}O₄/C.

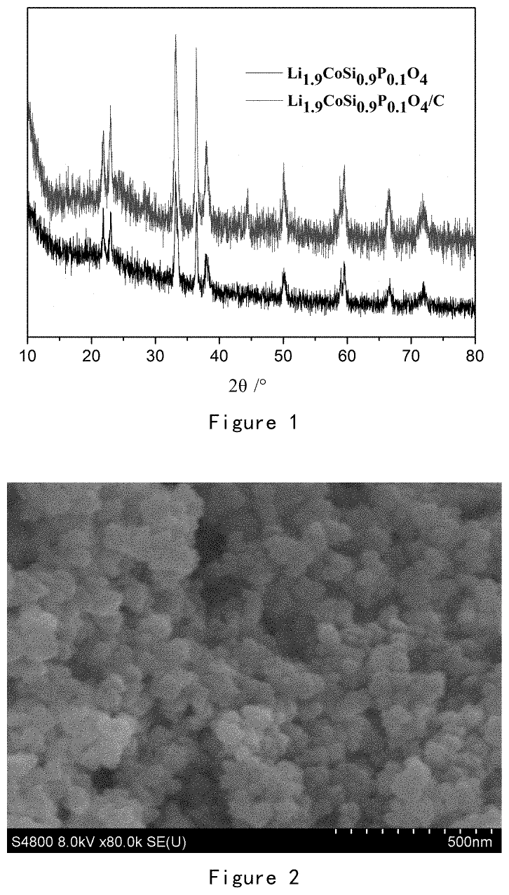

FIG. 1 is an XRD pattern of Li_{1.9}CoSi_{0.9}P_{0.1}O₄ and Li_{1.9}CoSi_{0.9}P_{0.1}O₄/C obtained in Example 1.

It can be seen from FIG. 1 that the uncoated Li_{1.9}CoSi_{0.9}P_{0.1}O₄ material is pure Pmn2₁ phase, and its XRD pattern has a distinct bimodal structure at 21.8° and 23.1′; the coated material Li_{1.9}CoSi_{0.9}P_{0.1}O₄/C has a distinct bimodal structure at 21.8° and 23.1°, and there is no new peak at 16.3 ° and 24.3°, maintaining the Pmn2₁ phase, but a Co elemental peak appeared at 44°. The above results indicate that the structure of Li_{1.9}CoSi_{0.9}P_{0.1}O₄ did not change before and after carbon coating, and only a small amount of Co ions are reduced to elemental Co.

FIG. 2 is an SEM picture of Li_{1.9}CoSi_{0.9}P_{0.1}O₄ obtained in Example 1.

It can be seen from FIG. 2 that the particles of Li_{1.9}CoSi_{0.9}P_{0.1}O₄ are uniform and the size is about 50 nm.

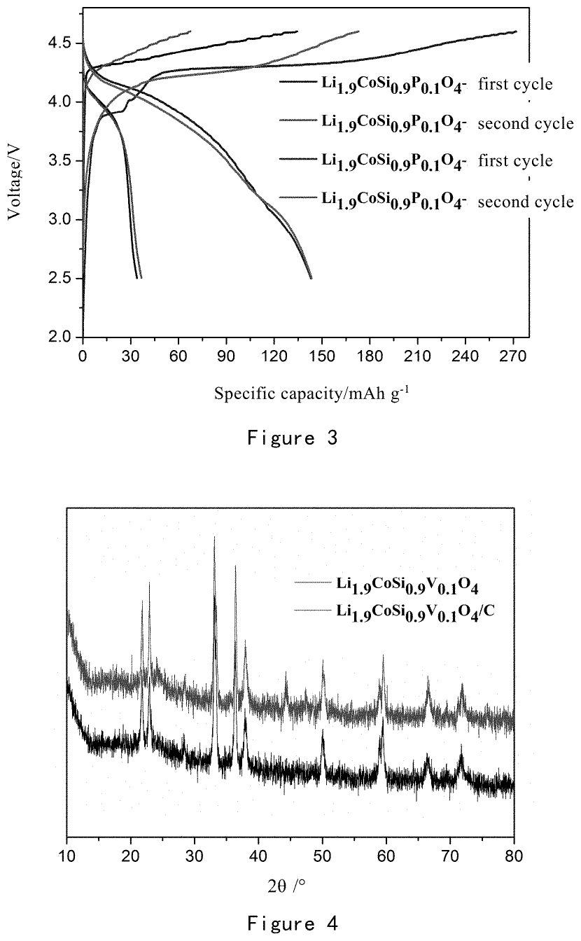

FIG. 3 shows the charge and discharge test results for lithium ion batteries using Li_{1.9}CoSi_{0.9}P_{0.1}O₄ and Li_{1.9}CoSi_{0.9}P_{0.1}O₄/C obtained in Example 1 as positive electrode active materials, respectively.

It can be seen from FIG. 3 that when charging and discharging at 5 mA/g, the lithium ion battery with Li_{1.9}CoSi_{0.9}P_{0.1}O₄ as the positive electrode active material has a first charge capacity of 134 mAh/g, and a first discharge capacity of 34 mAh/g; the lithium ion battery with Li_{1.9}CoSi_{0.9}P_{0.1}O₄/C as the positive electrode active material has a first charge capacity of 270 mAh/g and a first discharge capacity of 143 mAh/g; and, whether the lithium ion battery with Li_{1.9}CoSi_{0.9}P_{0.1}O₄ as the positive electrode active material or the lithium ion battery with Li_{1.9}CoSi_{0.9}P_{0.1}O₄/C as the positive electrode active material, its charging platform is basically 4.3V and has a significant discharge platform at 4.1V.

### EXAMPLE 2

### Silicate Positive Electrode Material 2 (Li_{1.9}CoSi_{0.9}V_{0.1}O₄/C)

2.1 Weighing lithium hydroxide (such as 1.2 mol) and silica nanopowder (such as 0.27 mol) with the molar ratio of Li to Si of 4:1, adding deionized water and fully stirred, configured as a suspension, and then placed in the ultrasonic device for 3 h;

2.2 Weighing the appropriate amount of cobalt chloride (such as 0.3 mol) and NH₄VO₃ (such as 0.03 mol), fully dissolved in ethylene glycol;

2.3 Adding the solution obtained in 2.2 slowly and uniformly to the solution obtained in 2.1, stirred, rotated at 1500 rpm;

2.4 Transferring the mixed solution obtained in 2.3 to the reaction vessel, and reacted at 150° C. for 72 h;

2.5 The reaction product obtained in 2.4 was suction filtered, washed for several times and dried;

2.6 The dried product obtained in 2.5 (such as 1.5 g) was mixed with sucrose (such as 0.42 g), ball milled for 12 h, then placed in a tube furnace, heated to 600° C. at 5° C./min in an inert atmosphere and calcined for 1 h;

2.7 The product was taken out after natural cooling, and the obtained product was the obtained silicate positive electrode material 2.

Result

Detected by ICP, the dried product obtained in 2.5 has a composition of Li_{1.9}CoSi_{0.9}V_{0.1}O₄, and the silicate positive electrode material 2 obtained in 2.7 has a composition of Li_{1.9}CoSi_{0.9}V_{0.1}O₄/C.

FIG. 4 is an XRD pattern of Li_{1.9}CoSi_{0.9}V_{0.1}O₄ and Li_{1.9}CoSi_{0.9}V_{0.1}O₄/C obtained in Example 2.

It can be seen from FIG. 4 that the uncoated Li_{1.9}CoSi_{0.9}V_{0.1}O₄ material is pure Pmn2₁ phase, and its XRD pattern has a distinct bimodal structure at 21.8° and 23.1′; the coated material Li_{1.9}CoSi_{0.9}V_{0.1}O₄/C also has a distinct bimodal structure at 21.8° and 23.1°, and there is no new peak at 16.3 ° and 24.3°, maintaining the Pmn2₁ phase, but a Co elemental peak appeared at 44°. The above results indicate that the structure of Li_{1.9}CoSi_{0.9}V_{0.1}O₄ did not change before and after carbon coating, and only a small amount of Co ions are reduced to elemental Co.

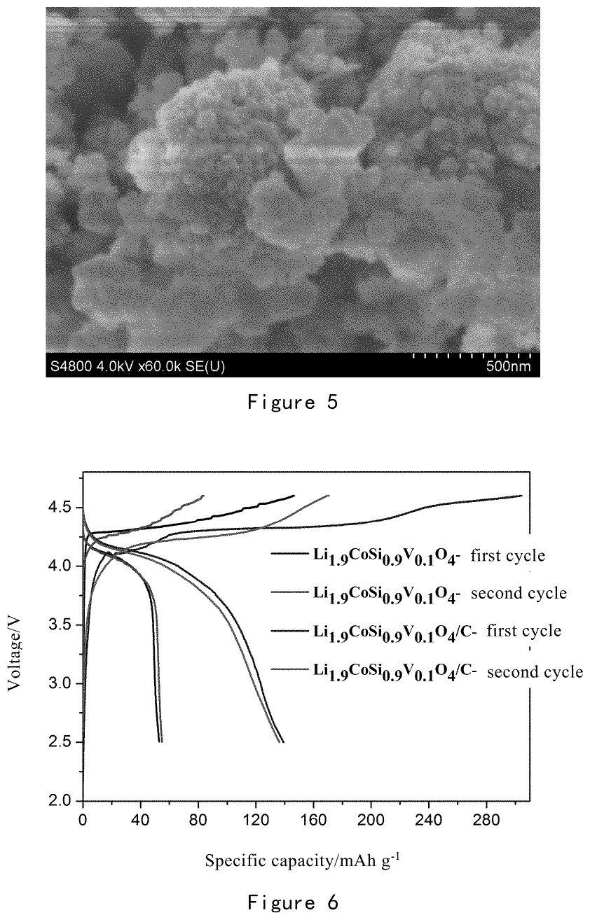

FIG. 5 is an SEM picture of Li_{1.9}CoSi_{0.9}V_{0.1}O₄ obtained in Example 2.

It can be seen from FIG. 5 that the particles of Li_{1.9}CoSi_{0.9}V_{0.1}O₄ are uniform and the size is about 50 nm.

FIG. 6 shows the charge and discharge test results for lithium ion batteries using Li_{1.9}CoSi_{0.9}V_{0.1}O₄ and Li_{1.9}CoSi_{0.9}V_{0.1}O₄/C obtained in Example 2 as positive electrode active materials, respectively.

It can be seen from FIG. 6 that when charging and discharging at 5 mA/g, the lithium ion battery with Li_{1.9}CoSi_{0.9}V_{0.1}O₄ as the positive electrode active material has a first charge capacity of 146.5 mAh/g, and a first discharge capacity of 52.9 mAh/g; the lithium ion battery with Li_{1.9}CoSi_{0.9}V_{0.1}O₄/C as the positive electrode active material has a first charge capacity of 304.3 mAh/g and a first discharge capacity of 139.1 mAh/g; and, whether the lithium ion battery with Li_{1.9}CoSi_{0.9}V_{0.1}O₄ as the positive electrode active material or the lithium ion battery with Li_{1.9}CoSi_{0.9}V_{0.1}O₄/C as the positive electrode active material, its charging platform is basically 4.3V and has a significant discharge platform at 4.1V.

Example 3

### Silicate Positive Electrode Material 3 (Li₂Co_{0.9}Mn_{0.1}SiO₄/C)

3.1 Weighing lithium hydroxide (such as 1.2 mol) and silica nanopowder (such as 0.3 mol) with the molar ratio of Li to Si of 4:1, adding deionized water and fully stirred, configured as a suspension, and then placed in the ultrasonic device for 3 h;

3.2 Weighing the appropriate amount of cobalt chloride (such as 0.27 mol) and manganese chloride (such as 0.03 mol), fully dissolved in ethylene glycol;

3.3 Adding the solution obtained in 3.2 slowly and uniformly to the solution obtained in 3.1, stirred, rotated at 1500 rpm;

3.4 Transferring the mixed solution obtained in 3.3 to the reaction vessel, and reacted at 150° C. for 72 h;

3.5 The reaction product obtained in 3.4 was suction filtered, washed for several times and dried;

3.6 The dried product obtained in 3.5 (such as 1.5 g) was mixed with sucrose (such as 0.42 g), ball milled for 12 h, then placed in a tube furnace, heated to 600° C. at 5° C./min in an inert atmosphere and calcined for 1 h;

3.7 The product was taken out after natural cooling, and the obtained product was the obtained silicate positive electrode material 3.

Result

Detected by ICP, the dried product obtained in 3.5 has a composition of Li₂Co_{0.9}Mn_{0.1}SiO₄, and the silicate positive electrode material 3 obtained in 3.7 has a composition of Li₂Co_{0.9}Mn_{0.1}SiO₄/C.

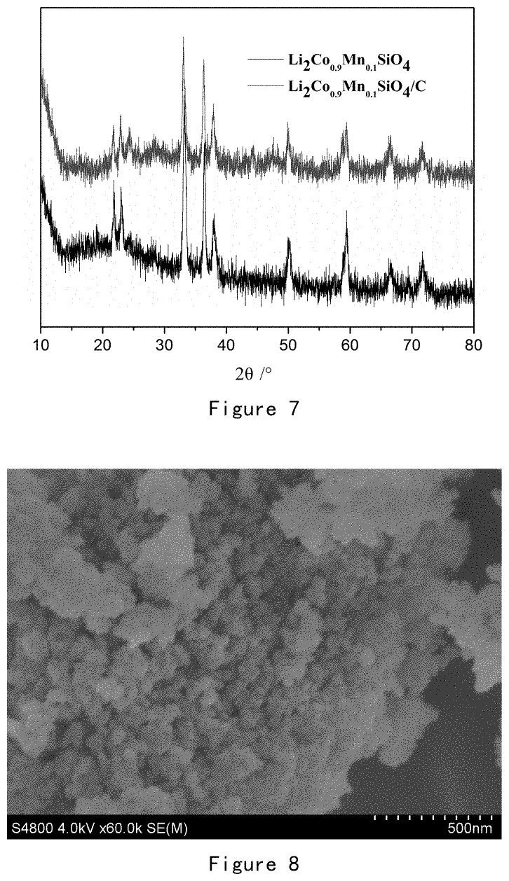

FIG. 7 is an XRD pattern of Li₂Co_{0.9}Mn_{0.1}SiO₄ and Li₂Co_{0.9}Mn_{0.1}SiO₄/C obtained in Example 3.

It can be seen from FIG. 7 that the uncoated Li₂Co_{0.9}Mn_{0.1}SiO₄ material is pure Pmn2₁ phase, and its XRD pattern has a distinct bimodal structure at 21.8° and 23.1′; the coated material Li₂Co_{0.9}Mn_{0.1}SiO₄/C still has a distinct bimodal structure at 21.8° and 23.1°, but peaks also appear at 16.3° and 24.3°, showing a mixed phase of Pmn2₁ and Pbn2₁, while a Co elemental peak appeared at 44°. The above results indicate that the structure of Li₂Co_{0.9}Mn_{0.1}SiO₄ did not change before and after carbon coating, and only a small amount of Co ions are reduced to elemental Co.

FIG. 8 is an SEM picture of Li₂Co_{0.9}Mn_{0.1}SiO₄ obtained in Example 3.

It can be seen from FIG. 8 that the particles of Li₂Co_{0.9}Mn_{0.1}SiO₄ are uniform and the size is about 50 nm.

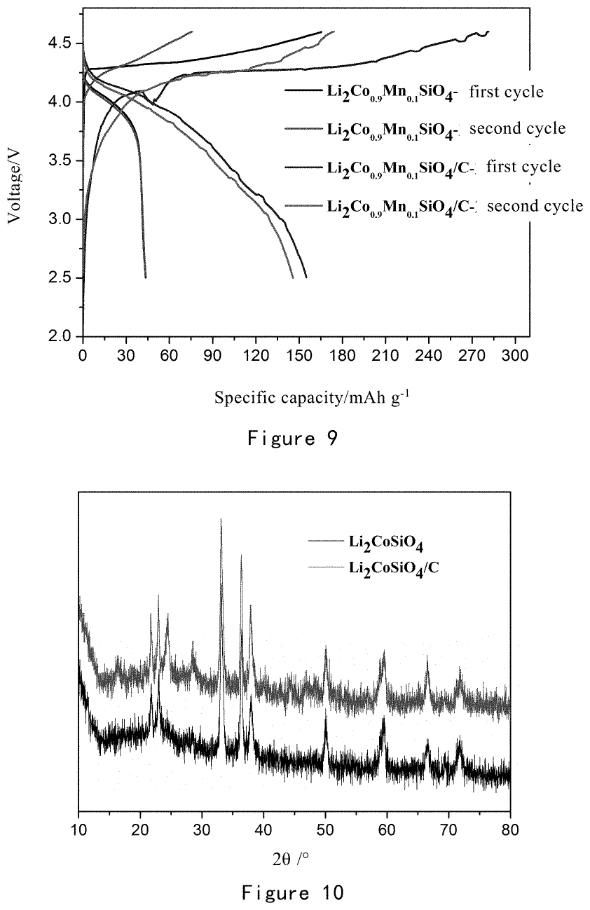

FIG. 9 shows the charge and discharge test results for lithium ion batteries using Li₂Co_{0.9}Mn_{0.1}SiO₄ and Li₂Co_{0.9}Mn_{0.1}SiO₄/C obtained in Example 3 as a positive electrode active material, respectively.

It can be seen from FIG. 9 that when charging and discharging at 5 mA/g, the lithium ion battery with Li₂Co_{0.9}Mn_{0.1}SiO₄ as the positive electrode active material has a first charge capacity of 165.4 mAh/g, and a first discharge capacity of 43.5 mAh/g; the lithium ion battery with Li₂Co_{0.9}Mn_{0.1}SiO₄/C as the positive electrode active material has a first charge capacity of 281 mAh/g and a first discharge capacity of 155 mAh/g; and, whether the lithium ion battery with Li₂Co_{0.9}Mn_{0.1}SiO₄ as the positive electrode active material or the lithium ion battery with Li₂Co_{0.9}Mn_{0.1}SiO₄/C as the positive electrode active material, its charging platform is basically 4.3V and has a significant discharge platform at 4.1V.

### COMPARATIVE EXAMPLE 1

### Silicate Positive Electrode Material C1 (Li₂CoSiO₄/C)

C1.1 Weighing lithium hydroxide (such as 1.2 mol) and silica nanopowder (such as 0.3 mol) with the molar ratio of Li to Si of 4:1, adding deionized water and fully stirred, configured as a suspension, and then placed in the ultrasonic device for 3 h;

C1.2 Weighing the appropriate amount of cobalt chloride (such as 0.3 mol), fully dissolved in ethylene glycol;

C1.3 Adding the solution obtained in C1.2 slowly and uniformly to the solution obtained in C1.1, stirred, rotated at 1500 rpm;

C1.4 Transferring the mixed solution obtained in C1.3 to the reaction vessel, and reacted at 150° C. for 72 h;

C1.5 The reaction product obtained in C1.4 was suction filtered, washed for several times and dried;

C1.6 The dried product obtained in C1.5 (such as 1.5 g) was mixed with sucrose (such as 0.42 g), ball milled for 12 h, then placed in a tube furnace, heated to 600° C. at 5° C./min in an inert atmosphere and calcined for 1 h;

C1.7 The product was taken out after natural cooling, and the obtained product was the obtained silicate positive electrode material C1.

Result

Detected by ICP, the dried product obtained in C1.5 has a composition of Li₂CoSiO₄, and the silicate positive electrode material C1 obtained in C1.7 has a composition of Li₂CoSiO₄/C.

FIG. 10 is an XRD pattern of Li₂CoSiO₄ and Li₂CoSiO₄/C obtained in Comparative Example 1.

It can be seen from FIG. 10 that the uncoated Li₂CoSiO₄ material is pure Pmn2₁ phase, and its XRD pattern has a distinct bimodal structure at 21.8° and 23.1′; the coated material Li₂CoSiO₄/C still has a distinct bimodal structure at 21.8° and 23.1°, but peaks also appear at 16.3° and 24.3°, showing a mixed phase of Pmn2₁ and Pbn2₁, while a Co elemental peak appeared at 44°. The above results indicate that the structure of Li₂CoSiO₄ did not change before and after carbon coating, and only a small amount of Co ions are reduced to elemental Co.

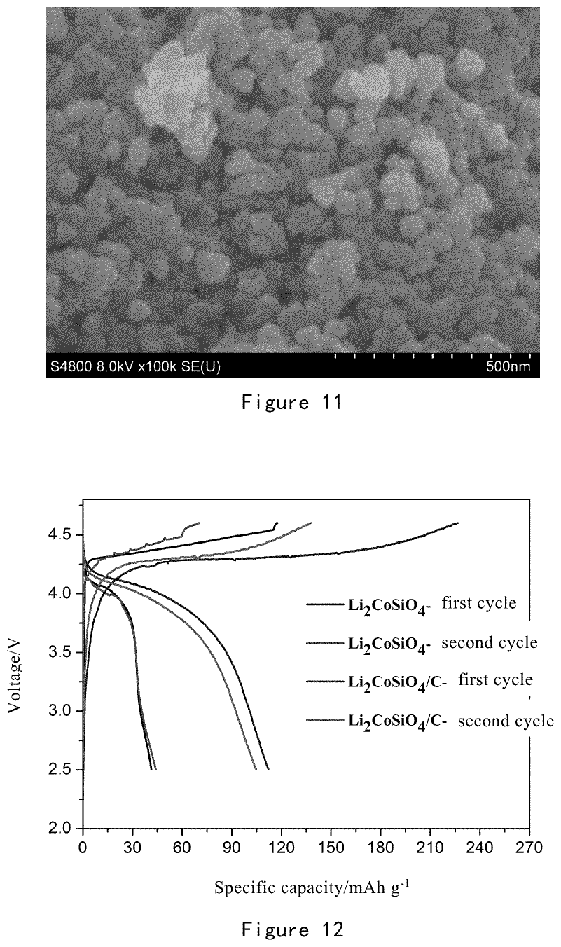

FIG. 11 is an SEM picture of Li₂CoSiO₄ obtained in Comparative Example 1.

It can be seen from FIG. 11 that the particles of Li_{1.9}CoSiO₄ are uniform and the size is about 50 nm.

FIG. 12 shows the charge and discharge test result for a lithium ion battery using Li₂CoSiO₄ and Li₂CoSiO₄/C obtained in Comparative Example 1 as positive electrode active materials, respectively.

It can be seen from FIG. 12 that when charging and discharging at 5 mA/g, the lithium ion battery with Li₂CoSiO₄ as the positive electrode active material has a first charge capacity of 120 mAh/g, and a first discharge capacity of 40 mAh/g; the lithium ion battery with Li₂CoSiO₄/C as the positive electrode active material has a first charge capacity of 226 mAh/g and a first discharge capacity of 112 mAh/g; and, whether the lithium ion battery with Li₂CoSiO₄ as the positive electrode active material or the lithium ion battery with Li₂CoSiO₄/C as the positive electrode active material, its charging platform is basically 4.3V and has a significant discharge platform at 4.1V.

All literatures mentioned in the present invention are incorporated by reference herein, as though individually incorporated by reference. Additionally, it should be understood that after reading the above teaching, many variations and modifications may be made by the skilled in the art, and these equivalents also fall within the scope as defined by the appended claims.

1. A silicate positive electrode material, wherein the silicate positive electrode material comprises a core of LiₐCoₓT₁₋ₓSi_{y}O₄ and a carbon coating layer coated on an outer surface of the core, and the silicate positive electrode material comprises the a composition shown in Formula 1:
LiₐCoₓT₁₋ₓSi_{y}M_{1-y}O₄/C I
wherein T is a metal ion of metal elements selected from the group consisting of Mn, Fe, Ni, Ca, Mg, Al, La, Y, Sc, Zn, Cu, V, Mo, Tc, Ru, Rh, Pd, Cr, and a combination thereof; and the a valence of T is the same as a valence of Co in Formula I;
M is an ion of elements selected from the group consisting of P, V, Ti, Ge, Ga, N, F, S, and a combination thereof;
0<x≤1, 0<y≤1, and not both of x and y are 1; and
a value of a makes a total valence of the core of LiₐCoₓT₁₋ₓSi_{y}M_{1-y}O₄ 0.

2. The silicate positive electrode material according to claim 1, wherein the silicate positive electrode material is a solid solution material.

3. The silicate positive electrode material according to claim 1, wherein M is a doping element in the silicate positive electrode material.

4. The silicate positive electrode material according to claim 1, wherein the silicate positive electrode material has a particle diameter of 5 to 500 nm.

5. The silicate positive electrode material of claim 1, wherein the silicate positive electrode material has one or more characteristics selected from the group consisting of:
1) when a lithium ion battery prepared by using the silicate positive electrode material as a positive electrode active material is discharged at a current density of 5 mA/g, its reversible discharge specific capacity is higher than 130 Ah/kg;
2) a discharge voltage platform of a lithium ion battery prepared by using the silicate positive electrode material as a positive electrode active material is higher than 4V; and
3) a lithium ion battery prepared by using the silicate positive electrode material as a positive electrode active material does not exhibit a structural voltage drop during the cycle.

6. A method for preparing the silicate positive electrode material according to claim 1, wherein the method comprises the following steps:
1) providing a first solution, a second solution, and a carbon source material, wherein the first solution comprises a first solvent, a lithium source material, and a silicon source material; the second solution comprises a second solvent, a cobalt source material, a T source material, and/or an M source material;
2) mixing the first solution and the second solution under stirring to obtain a precursor solution;
3) transferring the precursor solution to a reaction vessel, and reacting for time t1 at a first temperature T1;
4) suction filtrating and optionally washing and drying the product obtained in step 3) to obtain a core of the silicate positive electrode material of claim 1;
5) mixing the product obtained in step 4) with the carbon source material, and calcining a resulting mixture for time t2 at a second temperature T2 to obtain the silicate positive electrode material of claim 1.

7. The method of claim 6 wherein the lithium source material is selected from the group consisting of lithium hydroxide, lithium oxide, and a combination thereof;
the silicon source material is selected from the group consisting of silicon oxide, tetraethyl orthosilicate, methyl orthosilicate, silicate, silicone, and a combination thereof;
the cobalt source material is a cobalt salt selected from the group consisting of acetate, hydrochloride, sulfate, nitrate, carbonate, hydrogencarhonate, citrate, halogenated salt, and a combination thereof;
the T source material is a T salt selected from the group consisting of acetate, hydrochloride, sulfate, nitrate, carbonate, hydrogencarbonate, citrate, halogenated salt, and a combination thereof;
the M source material is a substance comprising M element selected from the group consisting of an acid, an ammonium salt, an oxide, a lipid substance;
the carbon source material is an organic carbon source, preferably selected from the group consisting of glucose, sucrose, citric acid, oxalic acid, acetic acid, and a combination thereof.

8. The method of claim 6 wherein T1 is 130-180° C.;
t1 is 1-150 h;
T2 is 400-800° C.;
t2 is 0.1-5 h.

9. A positive electrode of a lithium ion battery, wherein a positive electrode active material of the positive electrode comprises or consists of the silicate positive electrode material of claim 1.

10. A lithium ion battery comprising the positive electrode according to claim 9.
